(19) United States
(12) Patent Application Publication
(10) Pub. No.: US 2005/0085259 A1
(43) Pub. Date: Apr. 21, 2005

(54) Technique to coordinate wireless network over a power line or other wired back channel

(76) Inventors: W. Steven Conner, Hillsboro, OR (US); Xingang Guo, Portland, OR (US); Nandakishore R. Kushalnagar, Portland, OR (US); Liuyang L. Yang, Portland, OR (US); Jasmeet Chhabra, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/686,959

(22) Filed: Oct. 15, 2003

(51) Int. Cl. H04Q 7/20

(52) U.S. Cl. 455/552.1

(57) ABSTRACT

Various embodiments are described to coordinate a wireless network over a power line network or other wired back channel.

### BACKGROUND INFORMATION

In a wireless network, wireless nodes often communicate with one another to control or coordinate a variety of network tasks, including selecting communication frequencies, assigning time slots or channels, exchanging security related information such as encryption keys, etc. Sending control messages over a wireless network may reduce the wireless bandwidth available for data messages.

For a number of wireless protocols, such as 802.11, 802.15.3, Bluetooth, etc., coordination may be centralized at a coordinator/master node that may control time division multiple access (TDMA) scheduling and other coordination tasks such as power management, QOS (Quality of Service), etc., in the network. Network control and coordination may be simplified when all or at least some of the wireless nodes are in direct wireless communication with such a central coordinator. However, requiring a node to be within direct communication range of a central coordinator may limit deployment possibilities. Therefore, many of these wireless protocols may not easily support a multi-hop network of multiple access points (APs) or wireless routers. A multi-hop network may include, for example, a mesh or group of interconnected wireless nodes in which each node may not be in direct wireless communication with all the other wireless nodes. On the other hand, a single-hop network may be a network in which the wireless nodes may be in direct wireless communication with each other.

A multi-hop network may offer a number of advantages over a single-hop network, such as increased capacity due to spatial reuse and extended range. However, multi-hop networks in some cases may trade-off network performance since coordination across multiple hops may be more difficult and expensive than coordination for a single-hop network.

Therefore, a need may exist for an improved technique to handle control or coordination messages in a wireless network, such as a multi-hop wireless network for example, without significantly sacrificing the effective data throughput.

### BRIEF DESCRIPTION OF THE DRAWINGS

FIG. 1 is a diagram illustrating an example of a wireless communication system in accordance with one embodiment of the invention.

FIG. 2 is a block diagram illustrating an example of a wireless communication system in accordance with another embodiment of the invention.

FIG. 3 is a block diagram illustrating aspects of a wireless communication system in accordance with yet another embodiment of the invention.

FIG. 4 is a block diagram illustrating an example of a wireless system in accordance with an embodiment of the invention.

FIG. 5 is a flow chart illustrating operation of one or more wireless nodes according to an example embodiment.

FIG. 6 is a block diagram of a clock system according to an example embodiment.

FIG. 7 is a flow chart illustrating a clock synchronization process according to an example embodiment.

### DETAILED DESCRIPTION

In the detailed description, numerous specific details are set forth in order to provide a thorough understanding of the embodiments of the invention. It will be understood by those skilled in the art, however, that embodiments of the invention may be practiced without these specific details. In other instances, well-known methods, procedures and techniques have not been described in detail so as not to obscure the foregoing embodiments.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as processing, computing, calculating, determining, or the like, refer to the action or processes of a computer or computing system, or similar electronic computing device, that manipulate or transform data represented as physical, such as electronic, quantities within the registers or memories of the computing system into other data similarly represented as physical quantities within the memories, registers or other such information storage, transmission or display devices of the computing system.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), flash memory, magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

It is worthy to note that any reference in the specification to “one embodiment” or “an embodiment” means in this context that a particular feature, structure, or characteristic described in connection with the embodiment may be included in at least one embodiment of the invention. The appearances of the phrase “in one embodiment” or “an embodiment” in various places in the specification do not necessarily refer to the same embodiment, but may be referring to different embodiments.

It should be understood that embodiments of the present invention may be used in a variety of applications. Although the present invention is not limited in this respect, the circuits disclosed herein may be used in many apparatuses such as in the transmitters and receivers of a radio system. Radio systems intended to be included within the scope of the present invention include, by way of example only, wireless local area networks (WLAN) devices and wireless wide area network (WWAN) devices including wireless network interface devices and network interface cards (NICs), base stations, access points (APs), gateways, bridges, hubs, cellular radiotelephone communication systems, satellite communication systems, two-way radio communication systems, one-way pagers, two-way pagers, personal communication systems (PCS), personal computers (PCs), personal digital assistants (PDAs), and the like, although the scope of the invention is not limited in this respect.

As used herein, the term packet may include a unit of data that may be routed or transmitted between nodes or stations or across a network. As used herein, the term packet may include frames, protocol data units or other units of data. A packet may include a group of bits, which may include one or more address fields, control fields and data, for example. A data block may be any unit of data or information bits.

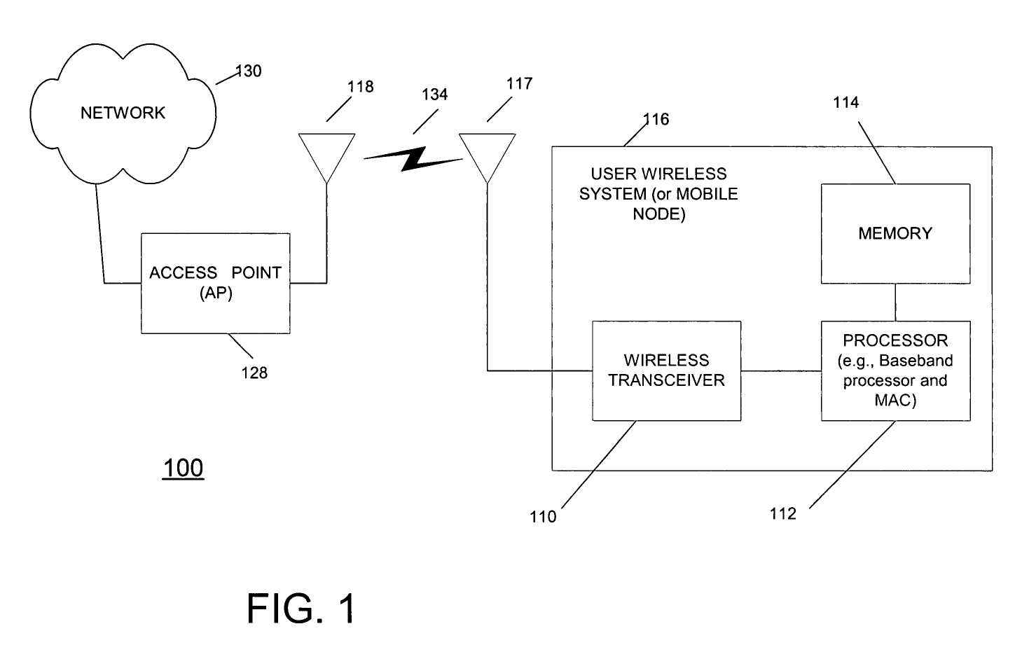

Referring to the Figures in which like numerals indicate like elements, FIG. 1 is a diagram illustrating an example of a wireless communication system in accordance with one embodiment of the invention. In the communications system 100 shown in FIG. 1, a user wireless system 116 may include a wireless transceiver 410 coupled to an antenna 117 and to a processor 112. Processor 112 in one embodiment may comprise a single processor, or alternatively may comprise a baseband processor and an applications processor, although the scope of the invention is not limited in this respect. According to one embodiment, processor 112 may include a baseband processor and Medium Access Control (MAC).

Processor 112 may couple to a memory 114 which may include volatile memory such as DRAM, non-volatile memory such as flash memory, or alternatively may include other types of storage such as a hard disk drive, although the scope of the invention is not limited in this respect. Some portion or all of memory 114 may be included on the same integrated circuit as processor 112, or alternatively some portion or all of memory 114 may be disposed on an integrated circuit or other medium, for example a hard disk drive, that is external to the integrated circuit of processor 112, although the scope of the invention is not limited in this respect. According to one embodiment, software may be provided in memory 114 to be executed by processor 112 to allow wireless system 116 to perform a variety of tasks, some of which may be described herein.

Wireless system 116 may communicate with an access point (AP) 128 (or other wireless system) via wireless communication link 134, where access point 128 may include at least one antenna 118. Antennas 117 and 118 may each be, for example, a directional antenna or an omni directional antenna, although the invention is not limited thereto. Although not shown in FIG. 1, AP 128 may, for example, include a structure that is similar to wireless system 116, including a wireless transceiver, a processor, a memory, and software provided in memory to allow AP 128 to perform a variety of functions. In an example embodiment, wireless system 116 and AP 128 may be considered to be stations in a wireless communication system, such as a WLAN system.

Access point 128 may be coupled to network 136 so that wireless system 116 may communicate with network 130, including devices coupled to network 130, by communicating with access point 128 via wireless communication link 134. Network 130 may include a public network such as a telephone network or the Internet, or alternatively network 130 may include a private network such as an intranet, or a combination of a public and a private network, although the scope of the invention is not limited in this respect.

Communication between wireless system 116 and access point 128 may be implemented via a wireless local area network (WLAN), for example a network which may be compliant with an Institute of Electrical and Electronics Engineers (IEEE) standard such as IEEE 802.11a, IEEE 802.11b, IEEE 802.11g and so on, although the scope of the invention is not limited in this respect.

In another embodiment, communication between wireless system 116 and access point 128 may be implemented via a cellular communication network compliant with a 3GPP standard, although the scope of the invention is not limited in this respect.

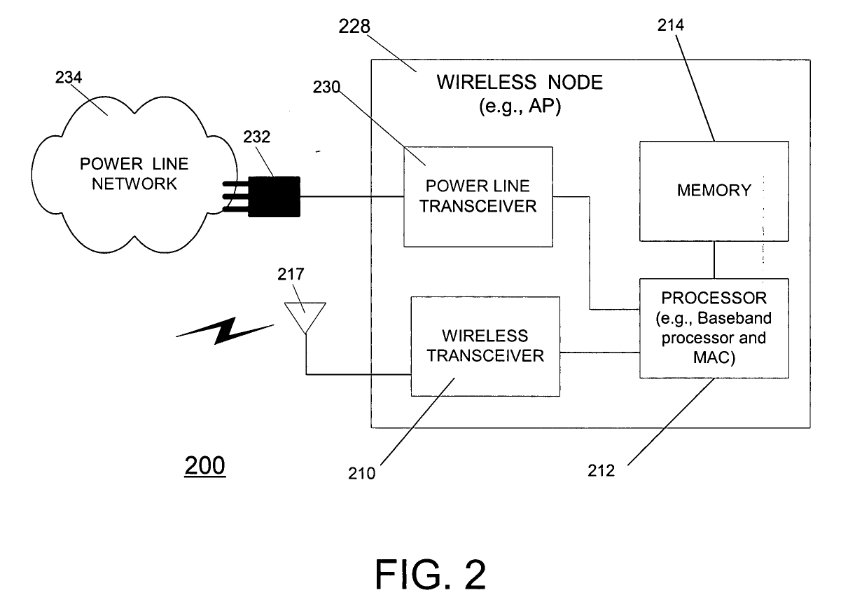

FIG. 2 is a block diagram illustrating an example of a wireless communication system in accordance with another embodiment of the invention. A wireless communication system is shown and may be referred to as a wireless node 228. Wireless node 228 may be an access point, a wireless router, or other wireless node.

Wireless node 228 may include a wireless transceiver 210 to transmit (or send) and receive messages over one or more wireless channels, via an antenna 217. Node 228 may, for example, also include a power line transceiver 230 (or other wired network transceiver) which may be coupled to a power line network 234 (or other wired network or wired back channel) via a power line plug (or adapter) 232. Power line network 234 may be, for example, common AC (alternating current) power distribution lines to distribute electrical power to or within a home or other facility, although the invention is not limited thereto. Power line transceiver 230 may send and receive messages over power line network 234 or other wired or wireless network back channel.

Wireless node 228 may also include a memory 214 to store programs and other data and a processor 212 which may execute programs. Processor 212 may be coupled to memory 214, and transceivers 210 and 230. The term back channel may be used to indicate that the wired network (e.g., power line network 234) or back channel is separate from a main data network (the wireless channel), although the invention is not limited thereto.

In operation, according to an example embodiment, wireless nodes (such as wireless node 228) may send and receive one or more control messages over power line network 234 or other wired network or wired back channel to coordinate the operation of one or more wireless channels or wireless networks, such as to coordinate data communications over the wireless channel(s) between the wireless nodes, although the invention is not limited thereto. Therefore, wireless nodes may use the power line network or other wired network as an alternative to using the wireless channel to exchange control messages to coordinate data communication over the wireless channel(s). A power line network may be convenient, since it is typically already present in a home or other facility. The power line network or other wired network may provide a reliable and deterministic link that may extend beyond the range of wireless signals. According to an example embodiment, the power line network or other wired network may be used to remove or offload some of the control or coordination bandwidth overhead from the wireless channel.

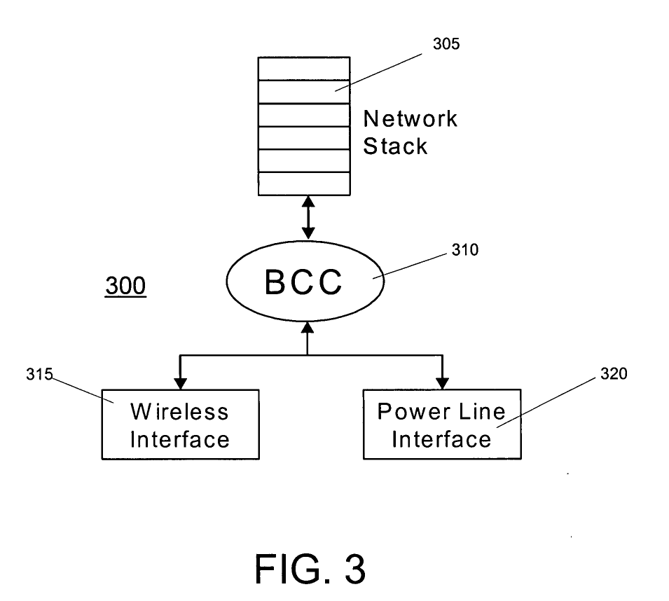

FIG. 3 is a block diagram illustrating aspects of a wireless communication system in accordance with yet another embodiment of the invention. The wireless communication system or wireless node 300 may include a back channel coordinator (BCC) 310 that may be coupled between (or in communication with) a network (or protocol) stack 305 and a wireless interface 315 and a power line interface 320. The wireless interface 315 may be a software interface, such as for interfacing to the wireless transceiver 210 (FIG. 2), and the power line interface 320 may be a software interface for interfacing to power line transceiver 230 (FIG. 2), although the invention is not limited thereto. According to example embodiments, BCC 310 may be, for example, hardware, software being executed by processor 212 (FIG. 2) or a combination of hardware and software, although the invention is not limited thereto.

The BCC 310 may perform a variety of tasks, including receiving packets from network stack 305, identifying whether the packet should be transmitted over the power line network or the wireless channel and then forwarding the packet onto the appropriate transceiver either via interface 315 or 320. BCC 310 may identify whether the packet should be sent to the wireless channel or to the power line network through pattern matching, based on a flag or field in the packet (e.g., indicating the packet is either a control packet or a data packet), or other information, although the invention is not limited thereto. According to an example embodiment, the BCC 310 may identify control or network coordination packets (or certain types of these control/coordination packets) from the network stack and send these over the power line network 234 or other wired network.

Similarly, when control or coordination packets are received (e.g., via power line network 234), the BCC 310 may forward the packets to one or more components in the network stack 305 to process these packets. In this manner, at least some of the traffic for coordination of a wireless network (such as for a multi-hop network) may be offloaded to a power line network or other wired back channel network.

Therefore, the wireless nodes may leverage an existing wired or wireline network (such as power line network 234) as a convenient and non-interfering back channel to control or coordinate one or more aspects of data exchange (or data communication) over a high bandwidth wireless channel (or wireless network). In an example embodiment, the power line network or other wired network may be a dedicated control channel or dedicated control network that may be used for one or more types of control or coordination messages, although the invention is not limited thereto.

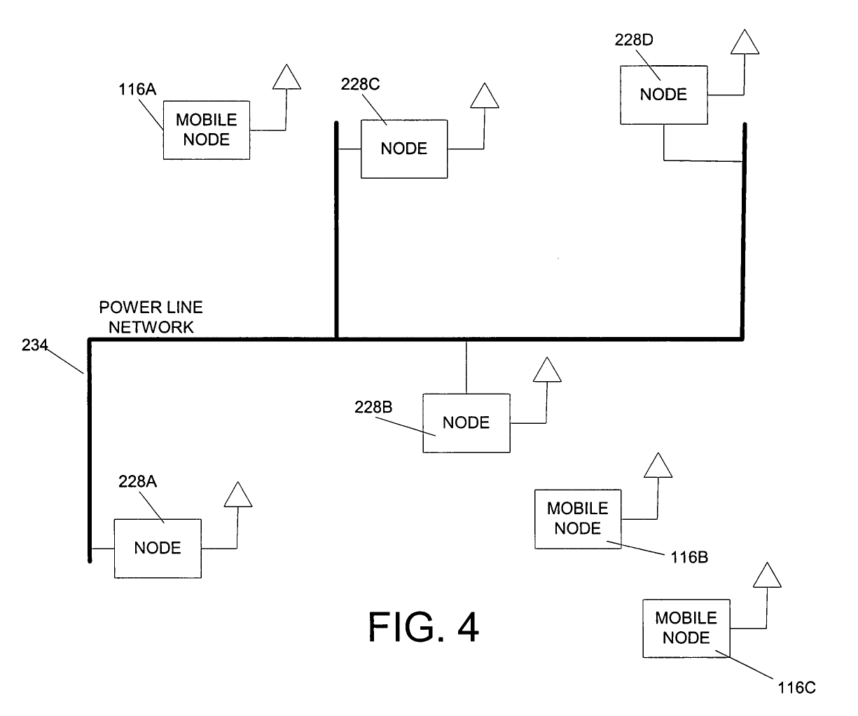

FIG. 4 is a block diagram illustrating an example of a wireless system in accordance with an embodiment of the invention. The wireless system in FIG. 4 may be a multi-hop wireless system, although the invention is not limited thereto.

The system in FIG. 4 may include a plurality of mobile wireless nodes 116, such as mobile nodes 116A and 116B. Mobile nodes 116 may not be wired typically to a power line network, but may rely on a battery for power during typical use (although such batteries may need to be recharged from time to time via a power line network or the like). Therefore, mobile nodes 116 may often be free to move about a building, home or other space. The mobile nodes 116 may be, for example, cellular phones, 802.11 NICs or computers, 802.11 Voice over IP phones, Bluetooth devices, wireless personal digital assistants (PDAs), etc., although the invention is not limited thereto.

Each of the mobile nodes 116 in FIG. 4 may be in communication with one or more wireless nodes 228, including wireless nodes 228A, 228B, 228C and 228D. Mobile nodes 116 may also be in communication with another mobile node. For example, depending on its location, mobile node 116C may be in direct communication with mobile node 116B, and may not be in direct communication with a fixed wireless node 228. Therefore, embodiments of the invention may be applied to multi-hop networks.

Each wireless node 228 may be a wireless router, an AP, a television with wireless capability, or other device, as examples. One or more of wireless nodes 228 may typically be plugged into the power line network 234 to obtain electrical power for operation. Therefore, wireless nodes 228 may have a semi-fixed location due to the wired connection to power line network 234. In addition to providing electrical power to nodes 228, power line network 234 may offer an alternative wired network to allow wireless nodes 228 to communicate control messages for coordinating one or more aspects of the data communication over the wireless channel(s).

There are many examples of network control or coordination messages which may be communicated between wireless nodes 228 over a wired back channel network (such as power line network 234) to coordinate data communication over a wireless channel(s). These control messages may relate to one or more aspects of data communication or other network aspects to be coordinated, and may include, for example, messages to establish communication schedules between wireless nodes 228, to exchange routing information or routing tables between wireless nodes 228, to select communication frequencies or channels, to request or assign time slots for a TDMA system, to exchange timing information such as local or global time for synchronization, to negotiate or request a particular quality of service (QoS), to negotiate security parameters or to exchange security related information such as encryption keys or to perform device authentication, to allow APs to exchange association tables, etc., although the invention is not limited thereto. There are many other types of control messages for wireless data communication which may be exchanged over a wired network or wired back channel.

According to an example embodiment, nodes 228 may be access points (APs). Each AP may include a list of the mobile nodes that are associated with that AP (or in communication with that AP), pursuant to 802.11, for example. An additional example of using the wired power line network 234 to exchange control or coordination messages may include APs exchanging association tables identifying the mobile nodes 116 that are associated with an AP or in communication with an AP. For example, when a mobile node 116 moves close to a new AP (a new node 228), the mobile node 116 may associate with the new AP. The new AP may then, for example, broadcast a message via the power line network 234 to the other APs in the home network that includes an association table identifying the mobile nodes that are associated with this AP (including this new mobile node). This may allow other APs to develop or update routing tables and to update their own association tables to remove a mobile from its own association table when it may have become associated with another AP. This is an example of how the wired back channel (e.g., power line network 234) may be used to exchange control messages between wireless nodes to coordinate an aspect of data communication over the wireless channel.

In addition, in some current wireless networks, significant portions of wireless bandwidth may be used simply to coordinate and maintain communication, particularly when the network must support quality of service (QoS). The dynamic nature of radio frequency (RF) channels may mean that connectivity and connection quality between nodes may change from time to time throughout the lifetime of the network. Thus, wireless nodes may frequently re-negotiate a QoS or other parameter to maintain coordinated communication. This coordination overhead may compete for available bandwidth with the data traffic. By using a wired back channel such as power line network 234 to offload at least some of this control/coordination traffic, significant wireless bandwidth may be conserved for data traffic. Moreover, in some cases, the use of a control channel (such as power line network 234) may allow more coordination messages to be exchanged between nodes and more frequently without interfering with data communication, providing an opportunity for improved optimization of wireless network performance.

In addition, according to an example embodiment, the power line network or other wired back channel may be more secure for the exchange of security and authentication related information, as compared to a wireless channel. For example, in a wireless channel, radio frequency (RF) signals may sometimes inadvertently travel through walls and allow communication with multiple networks in the neighborhood, creating possible opportunities for wireless eavesdropping, which may not be a problem for a wired network. Power-line filters may also be installed on power lines leading into homes or facilities to assist in preventing communication signals from leaving the home and entering the external power grid. Therefore, as compared to a wireless network, a power line network may be more appropriate for the exchange of security related information (such as encryption keys).

The broadcast nature of a power-line network may allow nodes in a home or facility to communicate directly with the other nodes in the home over the power line. As described above, some wireless networks may rely on a central coordinator node that may be within direct wireless communication of each node in the network. As compared to use of a wireless channel, the range for direct communication, e.g., from a central or coordinator node, may be extended when a wired back channel or wired network (such as power line network 234) is used. This may advantageously allow a coordinator node or other node to directly communicate with nodes in a multi-hop wireless network over the back channel or wired network. Therefore, it may be advantageous to use a wired back channel such as power line network 234 for network control/coordination messages in a network, such as multi-hop wireless network, although the invention is not limited thereto.

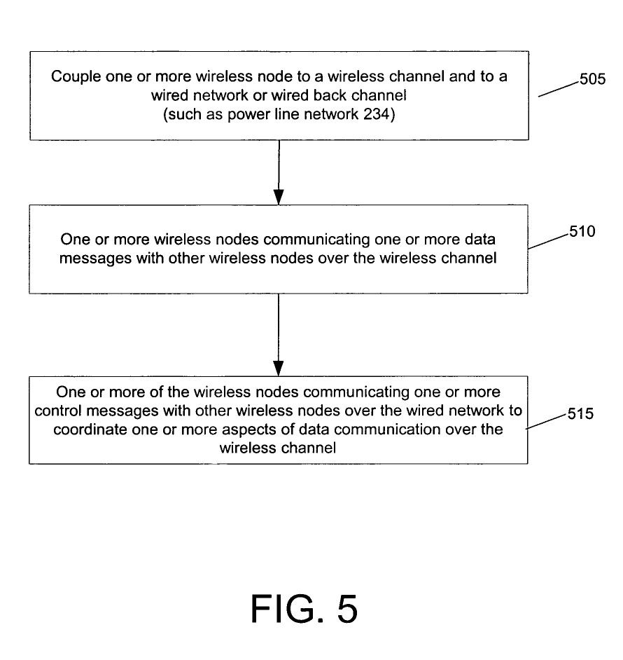

FIG. 5 is a flow chart illustrating operation of one or more wireless nodes according to an example embodiment. At 505, one or more wireless nodes may be coupled to both a wireless channel and to a wired network (such as power line network 234). At 510, one or more of the wireless nodes may communicate data messages with other wireless nodes over the wireless channel(s). At 515, one or more of the wireless nodes may communicate control messages with other wireless nodes over the wired network to coordinate one or more aspects of the wireless channel, such as to coordinate one or more aspects of data communication over the wireless channel.

In addition to supporting the exchange of general-purpose control and coordination messages for a network (such as a multi-hop wireless network), a power line network may also support improved time synchronization for wireless and wired networks.

Time synchronization between computers or nodes may be useful in a variety of applications. For example, in TDMA systems, each node may be assigned a time slot for transmission. Time synchronization may be useful in TDMA systems so that each of the nodes in the system may identify the beginning and end of each of the TDMA time slots, so as to prevent interference. When TDMA scheduling is used, each node in the network may maintain a local clock and attempt to remain synchronized with neighboring nodes or synchronized to a specified clock, such as a global clock.

Other examples where time synchronization between nodes in a network may be useful include where nodes may sleep during periods of inactivity. For example, a node may maintain communication schedules (e.g., using a clock) to allow the node to sleep when not communicating to save energy, and then to allow the node to wake during its TDMA time slot or when a local router or other device may be transmitting, although the invention is not limited thereto. Time synchronization may also be useful to allow a node to accurately synchronize different multimedia streams, such as synchronizing the display or output of local data overlayed onto a received video stream for display along with output of an audio stream.

In a network, such as a multi-hop wireless network for example, it may be desirable for nodes to maintain time synchronization. Time synchronization may include, for example, initially synchronizing each node to a pre-defined clock, and then reducing the clock drift among different nodes. Clock drift may be described as an error in clock timing or an inaccurate clock rate which may result in inaccurate clock value or time. In a multi-hop network and other networks, each node may maintain a local clock, e.g., by counting the oscillations of a built-in crystal oscillator. Since no two oscillators typically vibrate at exactly the same frequency, nodes will eventually fall out-of-synchronization. A current solution to clock drift is to let each node run or execute a protocol that periodically synchronizes with other node(s), exchanging information so as to detect and attempt to correct the clock drifts. An example of this type of protocol may be described in RFC 1305, “Network Time Protocol (Version 3), Specification, Implementation and Analysis,” 1992.

The power line connecting to a public power grid carries alternating current (AC), which oscillates at a fixed frequency (e.g. 60 Hz in U.S.). In some cases, this frequency may be maintained based on a highly accurate clock (e.g. atomic clock) by the power distributors. Furthermore, although they may affect the phase or amplitude of the current, disturbance sources, such as transformers and attenuators, typically do not alter the AC frequency. Therefore, once nodes are plugged into power outlets, the power line may provide a uniform, reliable and accurate clock or timing signal throughout a network. If each node periodically synchronizes its local clock to the AC oscillation on the power line (or synchronizes its local clock based on the AC signal), nodes in the multi-hop network may advantageously have reduced clock drift without having to exchange clock correction messages over the radio channel. This may be achieved, for example, with off-the-shelf hardware (e.g., such as is commonly used in digital clocks) which samples the AC signal and converts it to a 60 Hz digital pulse, although the invention is not limited thereto.

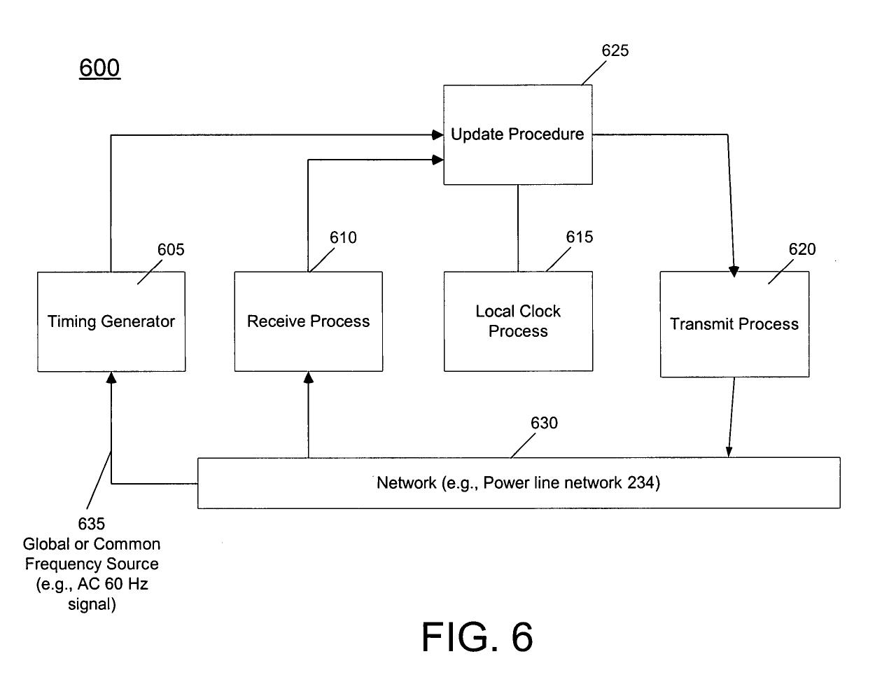

FIG. 6 is a block diagram of a local clock system according to an example embodiment. Local clock system 600 may be implemented in hardware, or preferably implemented in software that may be running or executing on processor 212 of wireless node 228 (FIG. 2). Local clock system 600 may maintain a local clock and may synchronize the local clock with a second clock, such as a global clock or a peer clock. According to an example embodiment, the local clock system may send a timing request message to a server (or other node) via transmit process 620 and via network 630. Network 630 may a wired network so as to decrease the variation of packet latency. However, a wireless channel may be used as well.

The timing request message may include a local time stamp, or the transmitting node may simply store the local time when this timing request message was transmitted. The message may be received by a server (that maintains a global clock). The server then adds information (such as a time stamp) to the message that allows the local clock system to determine the server (or global) time with respect to local time maintained by the local clock. In an example, embodiment, the server may return a message including a time stamp that indicates the time value of the clock at the server (e.g., global clock time). The message is then returned from the server to the sending node.

The receive process 610 may receive the return message and may calculate an offset between a peer clock (such as the global clock) and the local clock maintained by local clock system 610 based on one or more time stamps from the server, for example, although the invention is not limited thereto. This offset between the local clock and the global clock (or offsets from one or more peers) may then be received by the update procedure 625. The local clock process may then initialize the local clock to account for the offset between the global clock and the local clock. This process may be repeated to update the local clock from time to time. For example, the local clock process may update or adjust the local clock by adjusting the frequency and/or the phase of the local clock.

Therefore, it can be seen that a node may initially synchronize its local clock to another clock (e.g., peer clock or global clock) by exchanging timing messages with the other node, where the timing messages may include timing information such as time stamps. The time stamp information may advantageously be transmitted over a wired back channel or wired network such as network 234 to decrease a variation in network latency, as compared to using a wireless network. However, the problem of clock drift may still exist.

Therefore, according to an example embodiment, a global or common frequency source 635 (common timing signal) may be provided by power line network 234 (network 630) to a timing generator 605. The global or common timing source in this case may be a 60 Hz AC signal from the power lines, although the specific frequency may vary in individual countries. The timing generator 605 may generate, for example, a 60 Hz timing signal (e.g., a 60 Hz square wave) based upon the received AC Sine wave from power line network 234.

This 60 Hz timing signal 635 may then be input to the update procedure 625. Update procedure 625 may adjust the local clock (e.g., adjust the phase of the local clock) based on this common timing signal to decrease clock drift and/or to decrease clock error. Alternatively, one or more nodes may synchronize their local clock based only or based primarily on the common timing signal 635 provided from the power line network 234 or other wired network (e.g., without exchanging time stamps between nodes).

When it is desirable for one or more nodes in a network to synchronize to a single pre-defined clock, a clock synchronization protocol may be run on these nodes (e.g., to exchange time stamps) to initialize a local clock. In this case, the power line can provide a back-channel, as previously described, to carry timestamp information across the entire network. Moreover, clock drift may be decreased by using the 60 Hz frequency signal as a timing signal. In some cases, this may allow the frequency of time (clock) update (e.g., exchange of time stamps) by the protocol to be reduced.

Obtaining clock synchronization in a multi-hop wireless network, in some cases, may be challenging when relying on a wireless network to exchange time stamps because some nodes may not be in direct wireless communication with other nodes. However, the use of the power line network or other wired back channel may provide a more deterministic link (e.g., decreased variation in latency) to communicate timing messages between nodes.

Thus, a power line may be useful for clock synchronization in a multi-hop network (or other network) in several ways: being a reliable, accurate and cost-efficient source of a common or global timing signal, and also being a message carrying back channel that may be more immune to the delay characteristics than a wireless channel. Also, messages sent over the power line network may not compete for bandwidth with data traffic on the wireless links.

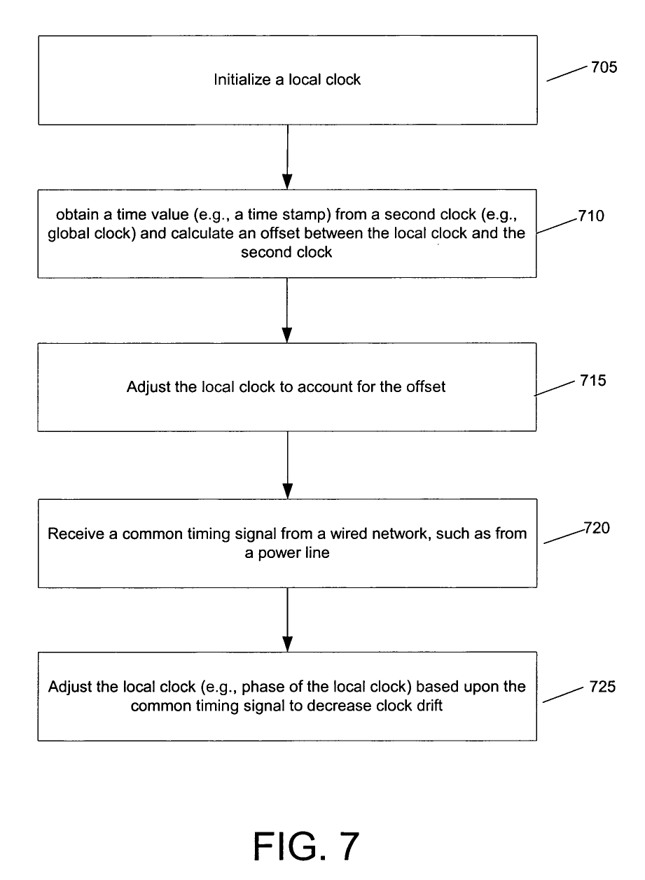

FIG. 7 is a flow chart illustrating a clock synchronization process according to an example embodiment. In FIG. 7, at 705, a node may initialize its local clock. At 710, the node may obtain a time value, such as one or more time stamps, from a second clock. The second clock may be a peer clock or a global clock, for example, at another node, although the invention is not limited thereto. The node may then calculate an offset or difference between the local clock and the second clock. At 715, the node may adjust its local clock to account for this offset, although the invention is not limited thereto.

At 720 in FIG. 7, the node may receive a common (or global) timing signal from a wired network or wired back channel. In an example embodiment, the node may receive a 60 Hz timing signal from a power line network. At 725, the node may then adjust the phase of its local clock based upon the common timing signal. This may allow the node to maintain time precision and reduce clock drift.

Therefore, according to an example embodiment, a common and accurate timing signal may be available to a plurality of nodes, such as wireless nodes in a TDMA multi-hop network, although the invention is not limited thereto. An example of the timing signal may be a 60 Hz signal from the power line network, although the invention is not limited thereto. The nodes may receive a time value, such as one or more time stamps, from a second or global clock to adjust their local clocks. Each node may also reduce clock drift by adjusting its local clock based on this common timing signal.

Note that some of the example embodiments described herein may include a wired power line network as a back channel used for coordination in a wireless network since power lines tend to be conveniently present in most wireless network deployments, especially within the home or other building. However, the various embodiments of the invention are not limited to the use of power lines for coordination. In fact, any network infrastructure, wired or otherwise (e.g., Ethernet or token ring networks, telephone lines), may be used as a back channel to coordinate the operation of nodes in a high-bandwidth wireless network. Nevertheless, power line back channels have several distinct advantages over other wired back channels, including that no new wires need to be installed when deploying a wireless network in an indoor environment and an AC power line may provide a common timing signal which may be used to assist in clock synchronization.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A wireless communication system comprising:
a wireless transceiver to transmit and receive information to one or more other wireless communication systems over a wireless channel;
an antenna coupled to the wireless transceiver;
a wireline transceiver to transmit and receive information over a wireline network;
a processor coupled to the wireline transceiver and the wireless transceiver, wherein the communication system is adapted to send and receive one or more data messages over the wireless channel and to send and receive one or more control messages over the wireline network to coordinate one or more aspects of communication over the wireless channel.

2. The wireless communication system of claim 1 wherein the wireless communication system comprises either a wireless access point (AP) or a wireless router.

3. The wireless communication system of claim 1 wherein the communication system is adapted to coordinate one or more aspects of data communication over the wireless channel.

4. The wireless communication system of claim 1 wherein the communication system is adapted to communicate control messages over the wireline network to coordinate one or more aspects of data communication over the wireless channel, the one or more aspects to be coordinated to be selected from the group comprising:
to establish communication schedules between nodes;
to exchange association tables between nodes or access points;
to exchange routing tables or routing information between nodes;
to exchange information between nodes related to the assignment of channels, frequencies or time slots in a multiple access system;
to exchange timing information between nodes;
to exchange information between nodes relating to clock synchronization;
to exchange information between nodes related to the request, negotiation or enforcement of a Quality of service (QoS); and
to exchange security related information between nodes.

5. The wireless communication system of claim 1 wherein the wireline transceiver comprises a power line transceiver to transmit and receive information over a power line network.

6. A wireless node comprising:
a wireless transceiver to transmit and receive information to one or more other wireless nodes over a wireless channel;
a power line transceiver to transmit and receive information to other nodes over a power line network; and
a processor coupled to said transceivers, wherein the node is adapted to communicate one or more control messages over the power line network to coordinate one or more aspects of communication over the wireless channel between the nodes.

7. The wireless node of claim 6 wherein the node is adapted to communicate one or more control messages over the power line network to coordinate one or more aspects of communication over the wireless channel between the nodes, the one or more aspects to be coordinated to be selected from the group comprising:
to establish communication schedules between nodes;
to exchange association tables between nodes or access points;
to exchange routing tables or routing information between nodes;
to exchange information between nodes related to the assignment of channels, frequencies or time slots in a multiple access system;
to exchange timing information between nodes;
to exchange information between nodes relating to clock synchronization;
to exchange information between nodes related to the request, negotiation or enforcement of a Quality of service (QoS); and
to exchange security related information between nodes.

8. The node of claim 6 and further comprising an antenna coupled to the wireless transceiver.

9. A communication system comprising:
a wireline network; and
one or more wireless nodes coupled to the wireline network, wherein one or more of the wireless nodes are adapted to communicate one or more data messages with other wireless nodes over a wireless channel and to communicate control messages with other wireless nodes over the wireline network to coordinate one or more aspects of the communication of messages over the wireless channel.

10. The communication system of claim 9 wherein the wireline network comprises a power line network.

11. A method of transmitting messages between wireless nodes, one or more of the wireless nodes being coupled to both a wireless channel and a wireline network, the method comprising:
the one or more wireless nodes communicating one or more data messages over the wireless channel; and
the one or more wireless nodes communicating one or more control messages over the wireline network to coordinate one or more aspects of communication between the wireless nodes over the wireless channel.

12. The method of claim 11 wherein the one or more wireless nodes communicating one or more control messages over the wireline network comprises the one or more wireless nodes communicating one or more control messages over a power line network to coordinate one or more aspects of communication between the wireless nodes over the wireless channel.

13. The method of claim 12 wherein the one or more aspects of communication over the wireless channel to be coordinated to be selected from the group comprising:
to establish communication schedules between nodes;
to exchange association tables between nodes or access points;
to exchange routing tables or routing information between nodes;
to exchange information between nodes related to the assignment of channels, frequencies or time slots in a multiple access system;
to exchange timing information between nodes;
to exchange information between nodes relating to clock synchronization;
to exchange information between nodes related to the request, negotiation or enforcement of a Quality of service (QoS); and
to exchange security related information between nodes.

14. A method of using both a wireless network and a power line network comprising:
communicating one or more data messages over a wireless channel; and
communicating one or more control messages over a wireline network to coordinate one or more aspects of communication over the wireless channel.

15. The method of claim 14 wherein the one or more aspects of communication over the wireless channel to be coordinated to be selected from the group comprising:
to establish communication schedules between nodes;
to exchange association tables between nodes or access points;
to exchange routing tables or routing information between nodes;
to exchange information between nodes related to the assignment of channels, frequencies or time slots in a multiple access system;
to exchange timing information between nodes;
to exchange information between nodes relating to clock synchronization;
to exchange information between nodes related to the request, negotiation or enforcement of a Quality of service (QoS); and
to exchange security related information between nodes.

16. An article comprising:
a storage medium;
said storage medium including stored thereon instructions that, when executed by a processor, result in:
communicating one or more data messages over a wireless channel; and
communicating one or more control messages over a wireline network to coordinate one or more aspects of communication over the wireless channel.

17. The article of claim 16 wherein the instructions resulting in communicating one or more control messages comprises communicating one or more control messages over a power line network to coordinate one or more aspects of communication over the wireless channel.

18. A method of clock synchronization comprising:
initializing a local clock;
obtaining a time value from a second clock;
calculating an offset between the local clock and the second clock;
adjusting the local clock based on the offset;
receiving a common timing signal from a wired network;
adjusting the local clock based upon the common timing signal.

19. The method of claim 18 wherein the receiving a common timing signal comprises receiving a common or global timing signal via a power line network.

20. The method of claim 18 wherein the receiving a common timing signal comprises receiving an AC power signal from a power line network.

21. The method of claim 18 wherein the adjusting the local clock based upon the common timing signal comprises adjusting a phase of the local clock based upon the common timing signal from a power line network to decrease clock drift.

22. The method of claim 18 wherein calculating an offset comprises calculating an offset between the local clock and the second clock based on a time stamp from the second clock and a network latency.

23. A node in a network, the node comprising:
a processor, the processor programmed to implement a local clock process, the local clock process to determine an initial time for a local clock, to receive a timing signal via a power line network, and to adjust the local clock based upon the timing signal.

24. A wireless multi-hop network comprising a plurality of wireless nodes, each of the wireless nodes comprising a node as recited in claim 23.

25. The node of claim 23 wherein the local clock process to determine an initial time for a local clock comprises the clock process to receive a time stamp

26. A method of clock synchronization comprising:
determining an initial time for a local clock;
receiving a timing signal via a power line network;
adjusting the local clock based upon the timing signal.

27. A method of clock synchronization for one or more nodes in a multi-hop wireless TDMA network, the method comprising:
determining an initial time for a local clock;
receiving a timing signal via a power line network;
adjusting the local clock based upon the timing signal; and
using the adjusted local clock to identify one or more TDMA time slots.
